(19) United States
(12) Patent Application Publication
(10) Pub. No.: US 2017/0010903 A1
(43) Pub. Date: Jan. 12, 2017

(54) USER INTERFACE LEVEL TUTORIALS

(71) Applicant: HEWLETT PACKARD ENTERPRISE DEVELOPMENT LP, Houston, TX (US)

(72) Inventors: Adi Kidron, Yehud (IL); Oded Keret, Yehud (IL); Ori Abramovsky, Yehud (IL); Roi Rosenthal, Yehud (IL); Karim Fanadka, Yehud (IL)

(21) Appl. No.: 15/107,073

(22) PCT Filed: Jan. 31, 2014
(86) PCT No.: PCT/US2014/014232

§ 371 Date: Jun. 21, 2016

(51) Int. Cl. G06F 9/44; G11B 27/031; G11B 20/10; G06F 3/0482

(52) U.S. Cl. CPC G06F 9/4446; G06F 3/0482; G11B 27/031; G11B 20/10527; G11B 2020/10537

(57) ABSTRACT

User interface level tutorials can be provided based upon recording as a tutorial a script and/or a video at a user interface level of progression through application-specific actions. Access to the tutorial can be provided based upon detection of an access to an application and/or a difficulty with the application.

### BACKGROUND

A challenge in the installation, modification, and/or use of an application is that the application might be used with various environments having many different combinations of configuration parameters (e.g., configurations). For instance, such configuration parameters could include different operating systems, different browsers, and/or different user interfaces, among other configuration parameters.

### BRIEF DESCRIPTION OF THE DRAWINGS

FIG. 1 illustrates a diagram of an example of a system for implementing user interface level tutorials according to the present disclosure.

FIG. 2 illustrates a diagram of an example computing device for implementing user interface level tutorials according to the present disclosure.

FIG. 3 illustrates a diagram of an example of an environment for implementing user interface level tutorials according to the present disclosure.

FIG. 4 illustrates a flow diagram of an example method for implementing user interface level tutorials according to the present disclosure.

### DETAILED DESCRIPTION

Users (e.g., clients, customers, purchasers, programmers, service technicians, program managers, among others) create, upload, download, access, install, modify, and/or use, among other interactions, many types of programmed, machine-readable instructions to perform particular functions (e.g., applications). Some such applications may be distributed on hardware, firmware, and/or software, whereas some such applications, which in some instances may be the same applications, may be accessible and/or usable through the Internet and/or service providers located in the “cloud” (e.g., in a cloud computing environment accessed via the Internet).

For example, access to the World Wide Web through the Internet has become an integral part of many people's activities. People may browse the Web for information (e.g., reading newspapers, blogs, etc.), to conduct transactions (e.g., buying products, services, etc.), and/or monitor finances (e.g., interact with checking, savings, investments, etc.), among many other uses. The goal of such Web browsing is often to accomplish a task. Each such task may be a sequence of web actions, such as visiting a website, clicking a link to select a category (e.g., the fiction category on a book seller website), clicking a link to select an item (e.g., a particular book), and clicking a button to add that item to a shopping cart. Execution of the actions on the website can accomplish a goal (e.g., buying the book). Some of these tasks may be performed repeatedly by various users. Automaton systems (e.g., Hewlett Packard® (HP) TruClient®, among others) can allow users to record scripts while conducting such tasks. The recorded scripts can be saved in a repository and reused at later times to automate such tasks for the original user and/or can be used as a tutorial to teach other users how to perform such a task.

Automaton systems can allow users to record scripts while conducting a task and such systems can allow a user can reuse a script recorded by another user. However, manually or automatically creating and/or sharing such scripts can have limitations. For example, a user may have personalized task needs particular to their own computer operating system (e.g., Microsoft® Windows®, Apple Inc.® Mac OS X®, Linux®, among others), browser (e.g., Internet Explorer®, Safari®, Mozilla Firefox®, among others), and/or graphical user interface (e.g., which can differ based on the type of computer, operating system, browser, and/or accessed application, among other configuration parameters) configurations for which no scripts have been created by other users or for which such scripts are difficult to find.

For example, a user may attempt to visit a travel website to check airline ticket prices and may encounter difficulties in navigating through and/or using the website, and another user may not have created and shared a script for accomplishing this task. In this situation, the user has to manually create the script. Similarly, if the user frequently checks airline ticket prices on different websites and another user has not created a script for those websites or has not made such a script available to other users, the user has to create a script for each of the websites in order to reuse them later. Although some web automaton systems facilitate the recording of scripts, this can be a labor intensive process. As a result, many users do not record scripts or keep such scripts to themselves and, thus, other users cannot take advantage of scripts recorded by such automaton systems.

In contrast, as described herein, user interface level tutorials can be provided based upon recording as a tutorial a script and/or a video at a user interface level (e.g., created, enabled, and/or verified with a particular operating system, browser, and/or user interface configuration as viewable on the user interface) of progression through application-specific actions (e.g., actions involved in installation, modification, and/or use of an application). As described herein, an access to the tutorial can be provided (e.g., provide optional access through a URL link automatically sent to a user by e-mail) based upon detection of an access to an application and/or a difficulty with the application (e.g., hesitation or a mistaken entry by a user during installation, modification and/or use of the application).

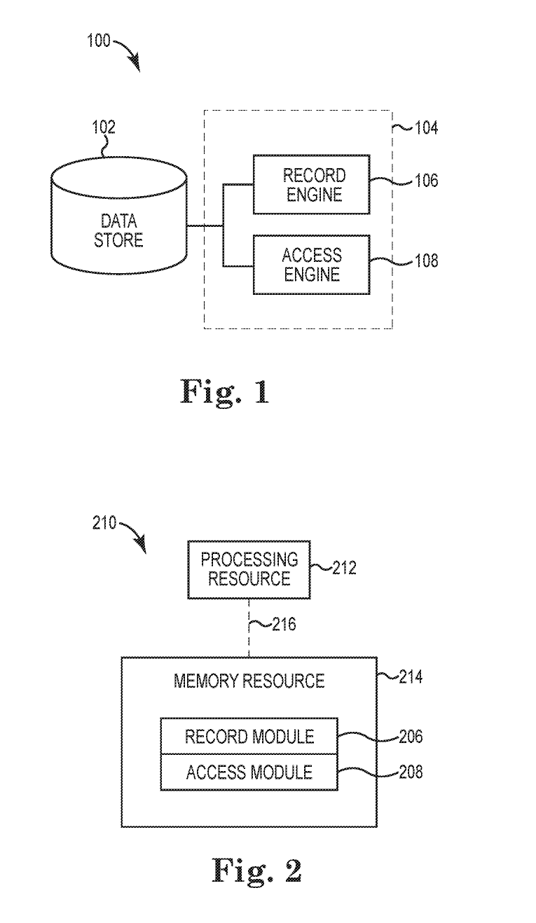

FIG. 1 illustrates a diagram of an example of a system for implementing user interface level tutorials according to the present disclosure. The system 100 can include a data store 102 operably connected to a number of engines 104 configured for implementing user interface level tutorials. The number of engines 104 can, for example, include a record engine 106 and an access engine 108. The number of engines 104 can include additional or fewer engines than illustrated to perform the various functions described herein. The number of engines 104 can be in communication with the data store 102 via a communication link.

The number of engines 104 can be represented as software, firmware, and/or hardware implementations. The number of engines 104 can include a combination of hardware and programming that is configured to perform a number of functions described herein. The programming can include program instructions (e.g., software, firmware, etc.) stored in a memory resource (e.g., including a number of machine-readable media (MRM), computer-readable media (CRM), etc.) as well as hard-wired programs (e.g., logic).

The record engine 106 can include hardware and/or a combination of hardware and programming to record as a tutorial at least one of a script and/or a video at a user interface level of progression through application-specific actions. In various examples, the application-specific actions can relate to and/or be utilized for installation, modification (e.g., changing security settings, linkages, etc.), and/or use of an application, among other application-specific actions.

The access engine 108 can include hardware and/or a combination of hardware and programming to provide access to the tutorial based upon detection of at least one of an access to an application and/or difficulty with the application. For example, the access engine 108 can automatically send optional access by providing a URL for downloading a script and/or a video that is sent to a user by e-mail.

FIG. 2 illustrates a diagram of an example computing device for implementing user interface level tutorials according to the present disclosure. The computing device 210 can utilize software, hardware, firmware, and/or logic to perform a number of the functions described herein. The computing device 210 can be any combination of hardware and program instructions configured to share information. The hardware, for example can include a processing resource 212 and/or a memory resource 214 (e.g., MRM, CRM, database, etc.) The processing resource 212, as used herein, can include any number of processors capable of executing instructions stored by the memory resource 214. The processing resource 212 may be integrated in a single device or distributed across a plurality of devices. Program instructions (e.g., machine readable instructions (MRI), computer-readable instructions (CRI), etc.) can include instructions stored on the memory resource 214 and executable by the processing resource 212 to implement a desired function (e.g., implementation of user interface level tutorials).

The memory resource 214 can be in communication with the processing resource 212 via a communication link (e.g., path) 216. The memory resource 214 can include any number of memory components capable of storing instructions that can be executed by the processing resource 212. Such a memory resource 214 can be non-transitory MRM or CRM. The memory resource 214 may be integrated in a single device or distributed across a plurality of devices. Further, the memory resource 214 may be fully or partially integrated in the same device as processing resource 212 or it may be separate but accessible to the processing resource 212. Thus, the computing device 210 may be implemented on a participant device, on a server device, on a collection of server devices, and/or on any combination of user devices, provider devices, and/or server devices, at least some of which may be located in the cloud.

The communication link 216 can be local or remote to a machine (e.g., a computing device) associated with the processing resource 212. Examples of a local communication link 216 can include an electronic bus internal to a machine (e.g., a computing device) where the memory resource 214 is one or more of volatile, non-volatile, fixed, and/or removable storage media in communication with the processing resource 212 via the electronic bus. Alternatively or in addition, at least some of the memory resource 214 and/or the processing resource 212 can be accessed (e.g., by a browser) in the cloud.

A number of modules 206, 208 can include instructions (e.g., MRI, CRI, etc.) that when executed by the processing resource 212 can perform a number of functions. The number of modules 206, 208 can be sub-modules of other modules. For example, a record module 206 and an access module 208 can be sub-modules and/or contained within the same computing device. In another example, the number of modules 206, 208 can include individual modules at separate and distinct locations (e.g., MRM, CRM, etc.).

Each of the number of modules 206, 208 can include instructions that when executed by the processing resource 212 can function as a corresponding engine, as described herein with regard to FIG. 1. For example, the record module 206 can include instructions that when executed by the processing resource 212 can function as the record engine 106 and/or the access module 208 can include instructions that when executed by the processing resource 212 can function as the access engine 108. In other examples, as described elsewhere herein, when executed by the processing resource 212, a video generation module (not shown) can include instructions that can function as a video generation engine (not shown), a conversion module (not shown) can include instructions that can function as a conversion engine (not shown), and/or an upload module (not shown) can include instructions that can function as an upload engine (not shown).

The present disclosure describes, in some examples, creating automated and/or semi-automated tutorial scripts for web applications automatically, using user interface level record and/or replay mechanisms (e.g., HP TruClient®). Such scripts can simplify the teaching, learning, and/or performance of application-specific actions for particular applications and can allow users to progress through otherwise complex use-cases in a quicker, easier, and/or automated way.

For example, various web applications may involve complex use-cases that may not be obvious to an inexperienced user. As such, when the inexperienced user tries to perform such use-cases, the user may encounter difficulties that the user desires to overcome with external help. Such help has previously been found in a few forms, including in in-product text documentation, in in-product documentation that contains images or videos, in external websites, such as forums or how-to videos published in video sharing websites (such as YouTube®), or by contacting a friend who knows how to use the application and asking the friend for advice. Such advice may be verbal (e.g., in speech over a telephone) or textual (e.g., in e-mail), and in some cases may include screenshots or a video screen recording taken using the friend's configurations (e.g., configuration parameters for the friend's operating system, browser, and/or user interface, among others).

However, these forms of help are not tutorials that are based on user interface level record and/or replay scripts that are matched to and/or enabled with the configuration parameters for the user's operating system, browser, and/or user interface, among others, in a way that automates and/or provides step-by-step instructions for progression through the wanted use-case for the inexperienced user. In some examples, the matched and/or enabled user interface level record and/or replay scripts of the tutorial described herein can automatically or semi-automatically perform the actions to effectuate the functions of the application.

For example, as described herein, a user can record interaction with a web application using a user interface level recording mechanism (e.g., HP TruClient®). The user can enhance the script to make sure it is replayable on a configuration the same as the user's and/or a number of different configurations having different configuration parameters (e.g., different operating systems, different browsers, and/or different user interfaces, among others). The user can enhance the script during or following creation of the script by adding specific script steps that can be used during use of the tutorial. For example, the user can add comments that will turn into call-outs for the user of the semi-automated script to enter relevant information when such information is not contained in the script (e.g., a user name, a password, etc.). The script can be uploaded (e.g., to a dedicated help server) accessible to users of the web application. An automated and/or a semi-automated tutorial script and/or video can be created based on the recorded script and, for example, a URL for downloading the recorded script can be sent to the user by e-mail.

In some examples, as described herein, creating video tutorials for applications (e.g., web applications) can be made quicker and/or easier using user interface level record and/or replay mechanisms. Such video tutorials can be particularly relevant in the world of web and/or mobile applications that change frequently, with new features and/or user interface elements added within days of release (e.g., with applications that utilize Agile, Continuous delivery methodologies). The video tutorials described herein involve no video recording and/or editing expertise on the part of the user, and no costly hardware and/or software add-ons, which means that it can be easily implemented by inexperienced users with no specialized equipment for recording and/or editing videos. As such, video tutorials can be created for, matched to, and/or enabled with the configuration parameters for the user's operating system, browser, and/or user interface, in addition to various different operating systems, browsers, and/or user interfaces, in a way that automates and/or provides step-by-step instructions for progression through a wanted use-case for the inexperienced user.

As described herein, a user can record interaction with a web application using a user interface level recording mechanism (e.g., HP TruClient®). Specific script steps can be added that can be used during creation of a tutorial video. For example, the user can add comments to the script that can be turned into video call-outs or pause steps, some of which can turn into frozen video frames in cases where the viewer needs time to understand what is happening. The script can, for example, be sent to a dedicated cloud service provider (e.g., with licensed video recording and/or editing software and sufficient hardware) where the script can be replayed and/or recorded into a video editing project. After the script is recorded, the specific steps added to the script can be used to automatically edit the video by adding the call-outs, pauses, freeze frames, etc. A video file can be created based on the video editing project and, in some examples, a URL for downloading the video file can be sent to the user by e-mail. The video file can be automatically uploaded to a video hosting service (e.g., YouTube®, Vimeo®, among others) and/or a user can have the video file downloaded (e.g., to be saved in digital memory and/or to be live video streamed).

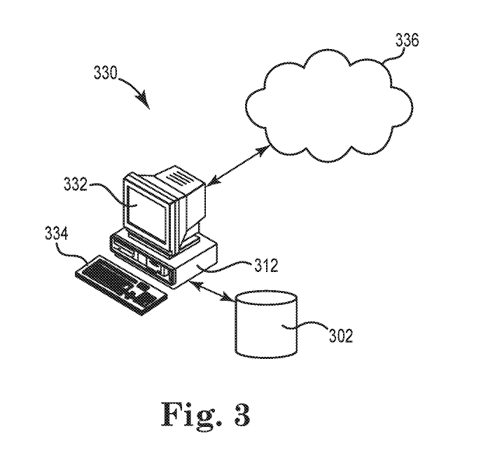

FIG. 3 illustrates a diagram of an example of an environment for implementing user interface level tutorials according to the present disclosure. FIG. 3 is a schematic diagram that includes a system 330 for a user interface level recording mechanism (e.g., HP TruClient®) that automatically records user actions for a number of automated or semi-automated scripts and/or videos, in accordance with the examples described herein. The system 330 can include an output device 332, such as a display screen (e.g., monitor) or other appropriate output device, for enabling a user to interact with a presented user interface. The output device 332 can present a user with results of a user action (e.g., interaction with an application, as described herein). The user interface level recording mechanism can include a script generation application, which, in various examples, can present a user via the output device 332 with a script, script options, and/or a result of running a script, among other displays.

The system 330 can include an input device 334. For example, the input device 334 can include one or more user operable input devices (e.g., a keyboard, keypad, mouse, pointing device, button, and/or other appropriate input devices). A user operating the input device 334 can input instructions to a script generation application and may perform operations that result in actions or events that are recorded by the script generation application.

The system 330 can include a processor 312 (e.g., the processing resource 212 shown in FIG. 2). The processor 312 can include a plurality of interacting or intercommunicating separate processors. The processor 312 can be programmed to run a script generation application. The processor 312 can, in addition, be programmed to run one or more additional applications. For example, the processor 312 can be programmed to run an application for interacting with a remote site via a network 336.

The processor 312 can interact with a data storage device 302 (e.g., the data store 102 shown in FIG. 1). The storage device 302 may include one or more fixed or removable data storage devices. The data storage device 302 can store programmed instructions (e.g., in the memory resource 214 shown in FIG. 2) for running one or more applications on the processor 312. The data storage device 302 can be utilized by a script generation application to store recorded actions and generated scripts.

The system 330 can communicate or interact with one or more remote devices, sites, systems, servers, or processors via the network 336. The network 336 can, in various examples, include any type of wired or wireless communications network that enables two or more systems to communicate or interact. For example, the network 336 can represent the Internet, the cloud, among other remote sites.

In various examples, as described herein, a user can interact with a user interface that automatically records user actions for a script via the script generation application. In some examples, user interaction with elements displayed on the user interface can be recorded (e.g., clicking of buttons and/or icons, entry of textual instructions and/or commands, opening and/or selection from a dropdown menu, among other such actions). In some examples, user initiated events are recorded (e.g., as opposed to recording every cursor and/or mouse movement, whether or not an event is generated).

For example, a user-controlled cursor (not shown) can interact with a menu. The menu can be designed such that when the cursor hovers over a menu item (e.g., remains positioned over that menu item for longer than a predetermined threshold time), that menu item is selected to be recorded in the script and/or video. If a dropdown menu is associated with the selected menu item, the dropdown menu can, for example, appear below the selected menu item.

A script generation application can, in some examples, initially classify actions in accordance with predetermined criteria. For example, such criteria may determine that any action that involves only cursor movement is to be initially not included in the script. Thus, the script generation application may initially include in the script only those actions that entail a change of a user interface screen (e.g., navigation to a web site) and/or that involve selection of a screen control (e.g., clicking on a menu item). Review of an initial script by a user for properly effectuating usage (e.g., in an automated and/or semi-automated manner) of an intended application (e.g., on the users own configuration parameters and/or different configuration parameters for operating systems, different browsers, and/or different user interfaces, among others) can result in reintroduction of actions that were initially excluded in order to enable proper installation, modification, and/or use of the application.

Examples of the present disclosure can automatically identify personalized tasks from a user's web browsing interaction history. For example, repeated sequences of similar actions on a single website can be identified from the user's web browsing interaction history and these sequences can be identified as a task. The identification of such tasks can assist in the creation of scripts by an automated system and, thus, can make script generation easier for the user.

For example, the schematic environment illustrated in FIG. 3 can include one or more systems 330 that are communicatively coupled to one or more networks 336. A number of web servers (not shown) can be communicatively coupled to the one or more networks 336. The one or more networks 336 can be one or more wide area networks, local area networks, wired networks, wireless networks, and/or other networks. Each web server can include web content (e.g., websites and/or their web pages) that is accessible by a user of the system 330 via an application such as a web browser (not shown).

In some examples, the system 330 can include the web browser and a script management system (e.g., a script manager) (not shown). The script manager can include a browsing monitor, a task identifier, a task model generator, and/or a script generator. The system 330 and/or the script manager also can, in some examples, include recorded browsing history information, web pages (and their document object models (DOMs)), and/or task models. In some examples, one or more of these components can reside outside of the system 330.

The browsing history monitor can monitor the user's browsing history including various actions taken by the user with respect to the web content using the web browser. The browsing monitor can continually record web browsing history at the level of user interface interactions (e.g., entering a value into a form field, turning on a checkbox, and/or clicking a button, among other such interactions). This goes beyond a conventional recorded web interface history to provide the script with a more complete picture of the actions performed on every web page that is visited, as compared to just recording page titles and/or URLs. The information recorded by the browsing monitor can be stored as the browsing history information.

For example, the task identifier can identify the following sequence of web actions as a task: visiting the website www.abc.com; clicking the link “tv”; clicking the link “lcd tv”; clicking the link “brand1 lcd”; clicking the button “add to shopping cart”; and clicking the “check out” button.

Task models can be created for each task. The task models can identify other instances of the task from web interactions on the same website or other websites. The script generator can use these identified tasks to automatically generate scripts that can be performed at the one or more websites in an automated and/or semi-automated manner. That is, after a task is identified, the script generator can use the identified task to automatically generate a script for the actions. The script can be a sequence of instructions, with each instruction corresponding to an action. For example, the following script can be generated for the example sequence of web actions presented above: go to www.abc.com; click the “tv” link; click the “lcd tv” link; click the “brand1 lcd” link; click the “add to shopping cart” button; and click the “check out” button.

Identifying personalized tasks from a user's web browsing interaction history can, in some examples, enable automatic creation of task specific scripts for later execution by a web automaton tool. Such scripts can later be reused by the same user or by other users. Also, the user can add to their personal script repository scripts created by other users. Further, task inference from a user's web browsing interaction history can be used in creating a user's personal script repository. For example, keywords identified from the user's task scripts can be added to the user's interest profile. For example, if the keywords “book” and “buy” are identified from a user's task script, then those can be added to user's interest profile. This can also be used to categorize the user as a frequent book buyer. Thus, task inference can assist the building of a task-based script repository for the user, which can be used by adaptive and/or context-aware systems, social networking applications, and/or mobile applications.

As such, as described in the present disclosure, a non-transitory medium (e.g., a MRM, a CRM, a database, etc.) can be utilized for storing instructions executable by a processing resource of the computing device. The instructions can, as in various examples described herein, be executed to implement user interface level tutorials.

Accordingly, a system (e.g., the system 330 shown in FIG. 3) to implement the user interface level tutorials can include a processing resource (e.g., the processing resource 212 shown in FIG. 2) in communication with a non-transitory medium (e.g., MRM, CRM, database, etc.) having instructions (e.g., in the data store shown in FIG. 1 and/or the memory resource shown in FIG. 2) executed by the processing resource. The instructions can be executed to implement a record engine (e.g., the record engine 106 shown in FIG. 1) to record as a tutorial at least one of a script and/or a video at a user interface level of progression through application-specific, as described herein, and an access engine to provide access to the tutorial (e.g., provide optional access through a URL link automatically sent to a user by e-mail) based upon detection of an access to an application and/or a difficulty with the application (e.g., hesitation or a mistaken entry by a user during installation, modification and/or use of an application).

In some examples, the system can include a video generation engine to automatically generate a video when a script (e.g., designated as a tutorial) is completed (e.g., the script is marked as and/or is moved to a folder to indicate completion). In some examples, the system can include a video generation engine to automatically generate a video at the user interface level upon detection of the difficulty with the application (e.g., such as hesitation and/or a mistaken entry by a user during installation, modification, and/or use of an application, among other difficulties) to enable analysis of the difficulty (e.g., determination of the difficulty by an entity associated with providing the application and/or the tutorial to provide a specific solution to the difficulty). In some examples, the system can include a video generation engine to automatically generate a number of videos at the user interface level of execution of a script (e.g., one script or a number of scripts to perform the same function) on a number of different configuration combinations selected from a plurality of operating systems, browsers, and/or user interfaces. Such videos can, for example, be used by an entity associated with providing the application and/or the tutorial to determine whether the application and/or features thereof are displayed and/or function appropriately on each of the different configuration combinations.

In some examples, the system can include a conversion engine in a dedicated cloud service that (e.g., after being uploaded, replayed, and/or recorded) automatically edits a script to create a video with additional visually displayable steps (e.g., call-outs, pauses, freeze frames, among other steps and/or features). In some examples, the system can include an upload engine linkable to a video hosting service (e.g., YouTube®, Vimeo®, etc.) to upload (e.g., automatically) a video tutorial (e.g., after completion thereof), where the uploaded video tutorial is subsequently at least one of downloadable (e.g., to digital memory by a user) and/or accessible by video streaming. The uploading, downloading, and/or streaming can, in some examples, be initiated by drag-and-drop (e.g., similar to dragging an .avi file to YouTube®).

As in various examples described herein, the instructions can be executed to record (e.g., automatically) progression at a user interface level through application-specific actions. The instructions can be executed to insert a call-out to be displayed (e.g., on a monitor and/or user interface) during replay of the progression as a tutorial, the call-out directed toward an application-specific action (e.g., performable automatically as directed by the tutorial or performable by a user) that enables progress through the progression. In some examples, the instructions can be executed so that the tutorial is linked to a defined action in an application such that when there is a difficulty (e.g., hesitation or a mistaken entry by a user, among other difficulties) the tutorial is automatically offered (e.g., to the user experiencing the difficulty).

In some examples, the call-out can be linked to a step in a script of the tutorial. For example, the call-out can be directed toward an action to be performed that is displayed on a monitor and/or user interface (e.g., an icon, menu choice, etc., to be selected/activated, an input for information not contained in the script, such as a user name, a password, among other actions). In various examples, the actions can be performed automatically by the tutorial and/or performed by the user. In some examples, to insert the call-out can include to insert (e.g., automatically) a pause in the progression of the tutorial until the application-specific action is performed (e.g., by the user). Such a pause can be used to identify that the user did an action correctly, confirm the correctness to the user, and progress to a next step in the script.

The instructions can, in some examples, be executed to record the progression as a script (e.g., a sequence of machine readable instructions) that automatically performs the application-specific actions. The instructions can, in some examples, be executed to record the progression as a script that semi-automatically leads through the progression of the application-specific actions (e.g., as a sequence of steps in textual and/or image format to be shown to a user, where at least one of the steps involves user interaction with a user interface). The instructions can, in some examples, be executed to record the progression as a video that shows the progression at the user interface level through the application-specific actions, where to insert the call-out includes automatically editing the video.

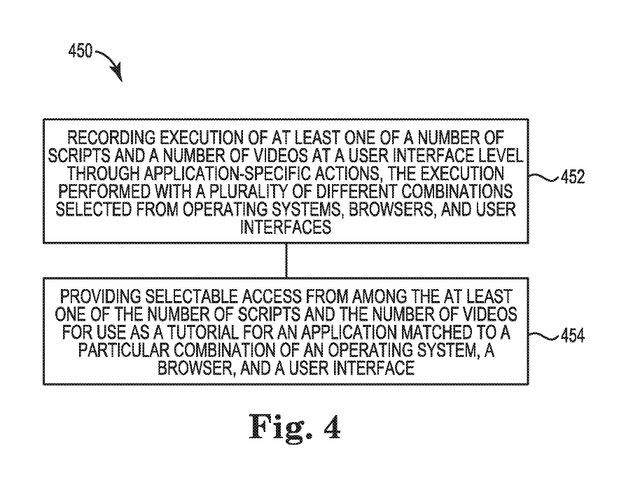

FIG. 4 illustrates a flow diagram of an example method for implementing user interface level tutorials according to the present disclosure. Unless explicitly stated, the method examples described herein are not constrained to a particular order or sequence. Additionally, some of the described method examples, or elements thereof, can be performed at the same, or substantially the same, point in time. As described herein, the actions, functions, calculations, data manipulations and/or storage, etc., can be performed by execution of non-transitory machine readable instructions stored in a number of memories (e.g., software, firmware, and/or hardware, etc.) of a number of applications. As such, a number of computing resources with a number of interfaces (e.g., user interfaces) can be utilized for implementing user interface level tutorials (e.g., via accessing a number of computing resources via the user interfaces).

The present disclosure describes a method 450 for implementing user interface level tutorials that utilizes a processing resource to execute instructions stored on a non-transitory medium. The method can include, as shown at 452 in FIG. 4, recording execution of at least one of a number of scripts and/or a number of videos (e.g., one script and/or video or a number of scripts and/or videos to perform the same function) at a user interface level through application-specific actions, the execution performed with (e.g., enabled on) a plurality of different configuration combinations selected from a plurality of operating systems, browsers, and/or user interfaces, among other configuration parameters. As shown at 454, the method can include providing selectable access from among the at least one of the number of scripts and/or the number of videos (e.g., to entities associated with providing the applications and/or the tutorials, to users, to websites, to browsers, to memories of computing devices, etc.) for use as a tutorial for an application matched to a particular configuration combination of an operating system, a browser, and/or a user interface, among other configuration parameters.

In various examples, the scripts and/or videos can be generated by one or more parties. Such parties can, for example, be selected from a group that includes an entity (e.g., a manufacturer, a programmer, a support service, a product team, a marketer, etc.) associated with providing the application to show a specific use case (e.g., matched to the particular combination of the operating system, the browser, and/or the user interface) to a user (e.g., a buyer, a customer, an on-line user, etc.); a user to share a solution to a difficulty with the application in connection with the particular combination of the operating system, the browser, and/or the user interface; a user to show the entity associated with providing the application a difficulty with the application in connection with the particular combination of the operating system, the browser, and/or the user interface; and/or a user to show the entity associated with providing the application how the user is actually using the application, among other parties.

Utilizing the user interface level tutorials described herein may provide a number of benefits. Utilizing the user interface level tutorials may lower support costs by, for example, providing a defined service structure that enables easier integration with other products (e.g., computer applications, etc.), lowering application development costs and/or upgrade costs because user interface level tutorials, as described herein, may be simpler than (e.g., less costly and/or time consuming than) and/or may involve less use cases for a provider of the application and/or tutorial. Utilizing the user interface level tutorials may provide users with a more efficient way of learning (e.g., by enabling) the installation, modification (e.g., changing security settings, linkages, etc.), and/or use of an application because tutorials that directly relate to their own operating systems, browser, and/or user interfaces may be easily found and/or automatically provided.

As used herein, “a”, “at least one”, or “a number of” an element can refer to one or more of such elements. For example, “a call-out” or “a number of scripts” can refer to one or more call-outs or scripts. Further, where appropriate, as used herein, “for example” and “by way of example” should be understood as abbreviations for “by way of example and not by way of limitation”.

The figures herein follow a numbering convention in which the first digit or digits correspond to the figure number and the remaining digits identify an element or component in the drawing. Similar elements or components between different figures may be identified by the use of similar digits. For example, 114 may reference element “14” in FIG. 1, and a similar element may be referenced as 214 in FIG. 2. Elements shown in the various figures herein may be added, exchanged, and/or eliminated so as to provide a number of additional examples of the present disclosure. In addition, the proportion and the relative scale of the elements provided in the figures are intended to illustrate the examples of the present disclosure and should not be taken in a limiting sense.

As described herein, a plurality of storage volumes can include volatile and/or non-volatile storage (e.g., memory). Volatile storage can include storage that depends upon power to store information, such as various types of dynamic random access memory (DRAM), among others. Non-volatile storage can include storage that does not depend upon power to store information. Examples of non-volatile storage can include solid state media such as flash memory, electrically erasable programmable read-only memory (EEPROM), phase change random access memory (PCRAM), magnetic storage such as a hard disk, tape drives, floppy disk, and/or tape storage, optical discs, digital versatile discs (DVD), Blu-ray discs (BD), compact discs (CD), and/or a solid state drive (SSD), etc., as well as other types of machine readable media.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processor.

It is to be understood that the descriptions presented herein have been made in an illustrative manner and not a restrictive manner. Although specific examples systems, machine readable media, methods and instructions, for example, for implementing user interface level tutorials, have been illustrated and described herein, other equivalent component arrangements, instructions, and/or device logic can be substituted for the specific examples presented herein without departing from the spirit and scope of the present disclosure.

What is claimed:

1. A system to provide user interface level tutorials, comprising a processing resource in communication with a non-transitory machine readable medium having instructions executed by the processing resource to implement:
a record engine to record as a tutorial at least one of a script and a video at a user interface level of progression through application-specific actions; and
an access engine to provide access to the tutorial based upon detection of at least one of an access to an application and a difficulty with the application.

2. The system of claim 1, comprising a video generation engine to automatically generate a video when a script is completed.

3. The system of claim 1, comprising a video generation engine to automatically generate a video at the user interface level upon detection of the difficulty with the application to enable analysis of the difficulty.

4. The system of claim 1, comprising a video generation engine to automatically generate a number of videos at the user interface level of execution of a script on a number of different combinations selected from operating systems, browsers, and user interfaces.

5. The system of claim 1, comprising a conversion engine in a dedicated cloud service that automatically edits a script to create a video with additional visually displayable steps.

6. The system of claim 1, comprising an upload engine linkable to a video hosting service to upload a video tutorial, wherein the uploaded video tutorial is at least one of downloadable and accessible by video streaming.

7. A non-transitory machine-readable medium storing instructions executable by a processing resource to:
record progression at a user interface level through application-specific actions; and
insert a call-out to be displayed during replay of the progression as a tutorial, the call-out directed toward an application-specific action that enables progress through the progression.

8. The medium of claim 7, wherein the tutorial is linked to a defined action in an application such that when there is a difficulty the tutorial is automatically offered.

9. The medium of claim 7, wherein the call-out is linked to a step in a script of the tutorial.

10. The medium of claim 7, wherein to insert the call-out comprises to insert a pause in the progression of the tutorial until the application-specific action is performed.

11. The medium of claim 7, comprising to record the progression as a script that automatically performs the application-specific actions.

12. The medium of claim 7, comprising to record the progression as a script that semi-automatically leads through the progression of the application-specific actions.

13. The medium of claim 7, comprising to record the progression as a video that shows the progression at the user interface level through the application-specific actions, wherein to insert the call-out comprises automatically editing the video.

14. A method for providing user interface level tutorials, comprising:
recording execution of at least one of a number of scripts and a number of videos at a user interface level through application-specific actions, the execution performed with a plurality of different combinations selected from operating systems, browsers, and user interfaces; and
providing selectable access from among the at least one of the number of scripts and the number of videos for use as a tutorial for an application matched to a particular combination of an operating system, a browser, and a user interface.

15. The method of claim 14, comprising generating the at least one of the number of scripts and the number of videos by a party selected from:
an entity associated with providing the application to show a specific use case to a user;
a user to share a solution to a difficulty with the application in connection with the particular combination of the operating system, the browser, and the user interface;
a user to show the entity associated with providing the application a difficulty with the application in connection with the particular combination of the operating system, the browser, and the user interface; and
a user to show the entity associated with providing the application how the user is actually using the application.
